(19) United States
(12) Patent Application Publication
(10) Pub. No.: US 2026/0004442 A1
(43) Pub. Date: Jan. 1, 2026

(54) 3D SCENE CAPTURE SYSTEM

(71) Applicant: Cambridge Enterprise Limited, Cambridge (GB)

(72) Inventors: Maciej TRZECIAK, Cambridge (GB); Ioannis BRILAKIS, Cambridge (GB)

(21) Appl. No.: 18/993,158

(22) PCT Filed: Jul. 11, 2023
(86) PCT No.: PCT/EP2023/069065

§ 371 Date: Jan. 10, 2025

(30) Foreign Application Priority Data
Jul. 11, 2022 (GB) 2210178.6

(51) Int. Cl. G06T 7/521; G06T 7/579; G06T 17/00

(52) U.S. Cl. CPC G06T 7/521; G06T 7/579; G06T 17/00; G06T 2200/24; G06T 2207/10024; G06T 2207/10028; G06T 2210/56

(57) ABSTRACT

A system is disclosed for scanning a structural object, comprising a mobile scanning device configured to scan the structural object from a plurality of successive locations to generate for each location a respective point cloud representing a respective portion of the structural object; a calculating unit configured to: (i) determine from the point clouds a pose graph comprising estimates of positions of the successive locations in relation to the structural object; and (ii) calculate for each location a respective uncertainty value in the pose graph; and a display configured to display the point clouds and to provide a visual indication for each point cloud of the calculated uncertainty value of the corresponding location in the pose graph.

### FIELD

The present application relates to scanning devices and methods for scanning a structural object such as a building, an earth formation or tunnel.

### BACKGROUND

Scanning structural objects is a key element for many applications in the Architecture, Engineering, Construction, and Operation (AECO) industry. Scanning may provide point clouds used for construction quality assurance, scan-to-BIM workflows and construction surveys. However, data acquisition using static laser scanners or photogrammetry methods is lengthy and requires even lengthier subsequent processing. Respective data sets may be captured when the scanning device is in each of a number of locations and labelled with geolocation data, and then the data sets are stitched together subsequently to form a composite image of the structural object. However, sometimes it is found that portions of the structural object are not covered adequately by any of the data sets, and additional data sets have to be collected.

An apparent solution to this problem is mobile mapping based on hand-held Lidar scanners. A Lidar scanner produces data in a form of a point cloud composed of points which correspond to respective points on the structural object, at respective point locations measured relative to the scanner position. Often Lidar scanners also include IMUs (inertial measurement units) and/or cameras. Lidar scanners typically perform simultaneous localization (i.e. tracking the position of the scanner) and mapping (capturing the point clouds), a process known as “SLAM”. Using the estimated positions of the scanner when the point clouds are captured, the point clouds may be aligned in a common three-dimensional coordinate system to form a composite point cloud. Unfortunately, known SLAM systems suffer gradually increasing spatial error as drift (cumulative error in localisation) increases. Drift skews the composite point cloud, and thus increases its spatial error. Therefore, it is not uncommon that there is a mix of static and mobile scanners on construction sites depending on the requirements of the use cases at hand.

Here, the spatial error is defined as a discrepancy between estimated locations of respective points of the point cloud and corresponding ground truth locations on the structural object. This corresponds with the geodetic “correctness” of point clouds, “absolute accuracy” or, simply, “accuracy”.

Two known SLAM paradigms are 1) filtering and 2) smoothing. The former focuses on the estimation of the most current pose (i.e position and/or orientation) of the scanner given all the measurements of its sensors. It is useful when SLAM is used by robots that must determine their position in real-time as accurately as possible. The latter focuses on the estimation of all the key poses (i.e. the poses of the scanner at a plurality of scanning locations) included in the trajectory of the scanner (i.e. the path it takes during the scanning operation, including the locations where the point clouds are captured).

Since the correctness of the point clouds produced when scanning a structural object is dependent on the trajectory, its wrong estimation will yield a skewed composite point cloud resulting in higher spatial error. Therefore, the smoothing SLAM paradigm is of interest in scanning structural objects because it focuses on the estimation of the whole trajectory, and hence the correctness of the produced point cloud as a whole.

There exist a number of SLAM methods under the smoothing paradigm. They model the above-described problem using a probabilistic graph based on the posterior distribution of points on the structural object given the point cloud, and then turn it into a problem involving minimizing non-linear least squares. Even with a relatively good initialization, however, there is no guarantee that such a problem can be executed in an acceptable time due to the number of iterations used during the optimization algorithm, which is generally considered computationally expensive. However, due to increasing computing power of mobile devices and recent scientific advancements in effective factorization methods, solving graph-based SLAM in near real-time has become increasingly possible.

The type of sensors used for SLAM also affects how the problem should be modelled. In cases where Lidar is involved, it is not uncommon to avoid modelling an explicit map of the scanned structural object (“scene”) and instead focus on the trajectory of the scanner only, since a stream of lidar points can yield relatively good odometric constraints between key poses. Modelling the problem this way is otherwise known as pose-graph SLAM and involves only the odometric constraints and loop closures. The latter is important since they provide constraints that allow creation of a globally consistent trajectory, and therefore a globally consistent map.

However, known SLAM frameworks still suffer from growing drift, resulting in worsening spatial error of the point clouds. They are not as accurate as the workflows based on static scanners and surveying, and there is no way to remove the drift in a user-aware manner.

### SUMMARY

Preferred embodiments of the present application aim to provide a novel, real-time and fully explainable method and system exploiting human-machine interaction to increase the correctness of point clouds produced when scanning a structural object.

In general terms, as a user traverses a scene using a scanner system capturing point clouds at multiple locations, the system propagates the uncertainty of odometric inter key-pose constraints in an underlying pose graph. The method progressively reconstructs the scanned scene and predicts regions of the reconstructed scene with a potentially high spatial error with a certain confidence level, e.g. a 95% confidence level. The system displays the point clouds with a visual indication of the predicted spatial error. The user can revisit parts of the scene, e.g. by taking a different route there through the structural object, which adds additional constraints on the underlying probabilistic graphical model, thus reducing the drift and increasing the confidence in the correctness of these regions.

The proposed system may be integrated into practical mobile scanning procedures. Prior to scanning, a user may choose a bottom level of point cloud correctness they are willing to accept (“acceptability threshold”). As the user traverses the scene, the progressively-built composite point cloud may initially be one colour, e.g. green, as the uncertainty is small relative to the origin of the point cloud (where the scanner started scanning); may then turn red, to indicate that the points are subject to spatial error above the acceptability threshold; and may gradually change colour, e.g. from red to green, when a loop in the pose graph is closed, indicating that the spatial error of the points is below the acceptability threshold. After the desired parts of the scene have been scanned, the user may revisit any parts of the scene that are coloured red, linking them with green areas to provide an additional constraint on the reconstruction of the scene in the red areas, with the aim of turning the remaining red part of the scene green.

In one specific expression, the present application describes a system, and corresponding method, for scanning a structural object. The system comprises a mobile scanning device configured to scan the structural object from a plurality of successive locations to generate for each location a respective point cloud representing a respective portion of the structural object. The system further comprises a calculating unit configured to: (i) determine from the point clouds a pose graph comprising estimates of positions of the successive locations in relation to the structural object; and (ii) calculate for each location a respective uncertainty value in the pose graph. The system additionally comprises a display configured to display the point clouds and to provide a visual indication for each point cloud of the calculated uncertainty value of the corresponding location in the pose graph.

This advantageously allows a user to easily identify regions of high uncertainty in a scan. Although uncertainty in certain parts of the composite point cloud is indicated, this is done without requiring an uncertainty calculation for each point, thus avoiding a need for the computational effort required to do such a calculation.

The system may be arranged such that the calculating unit is configured to determine the pose graph by optimizing, with respect to estimates of the positions of the successive locations, a maximum-a-posteriori loss function of the estimates of the positions of the successive locations. This is considerably computationally less expensive than optimizing a model based on estimated positions of the structural object and the locations of the scanner.

The system may be arranged such that the optimization of the maximum-a-posteriori loss function comprises deriving for each location a respective marginal covariance matrix. The uncertainty value for each location may be based on a highest eigenvalue of the marginal covariance matrix. In one example, the uncertainty value may be a confidence factor multiplied by the square root of the highest eigenvalue. The square root of the highest eigenvalue may be considered as a standard deviation of the distribution of possible positions of the corresponding location, so that the uncertainty value is, in effect, a number of standard deviations which is equal to the confidence factor.

As noted above, the visual indication for each point cloud may indicate whether the uncertainty value of the corresponding location is respectively above or below a predetermined acceptability threshold. Additionally, the system may be operative to receive a user selection of the acceptability threshold. For example, the user selection may indicate a selection of a surveying standard, and the calculating unit may be configured to determine the acceptability threshold based on (e.g. by being equal to or proportional to) a tolerance distance value associated with the selected standard. These features advantageously allow the system to be adapted depending on the user requirements. For example, since 95% of the weight of a Gaussian distribution is within 2 standard deviations of the mean, setting the acceptability threshold to be the tolerance distance, and setting the uncertainty value to be twice the square root of the highest eigenvalue, corresponds to specifying with 95% confidence that the spatial error in the pose is less than the tolerance distance value. This gives a proportionate confidence in the spatial error of corresponding point cloud. Similarly, using a confidence value of 3 would imply that the spatial error is below the acceptability threshold with 99.7% confidence.

The visual indication for each point cloud may in principle be of any form (e.g. the points of the point cloud may flash to indicate that there is low confidence that the spatial error is below the acceptability threshold). However, preferably it is a colour of the points of the displayed point cloud. This advantageously allows for easy identification of areas of high uncertainty which allows a user to understand which specific areas to revisit in real time.

Optionally, there may be a plurality of acceptability thresholds (e.g. user-specified acceptability thresholds), and the visual indication may include a colour which indicates the relationship between the uncertainty value and these plural acceptability thresholds. For example, points associated with a location having an uncertainty value above the lowest acceptability threshold may be displayed with a first colour, and points associated with a location having an uncertainty value below the highest acceptability threshold may be displayed with a second colour. Any points associated with a location have an uncertainty threshold between a certain pair of successive acceptability thresholds may be displayed with a corresponding third colour, different from the first and second colours.

The mobile scanning device may comprise a Lidar sensor. The mobile scanning device may additionally comprise an inertial measurement unit and may optionally comprise a camera.

The system may further comprise an indication unit configured to indicate corrective action to be performed by a user to reduce the levels of uncertainty in the pose graph. The corrective action may comprise closing a loop in the pose graph. The display may display an indication of the corrective action to be performed, e.g. directing the user to move to a location (e.g. the closest location) which causes the loop to close. This advantageously allows a user to reduce the uncertainty in a point cloud with a low distance of travel, and thus requiring a low travel time.

The mobile scanning unit, calculating unit and display may be provided within a common housing. This advantageously provides a single, portable unit that may be used for mobile scanning.

### BRIEF DESCRIPTION OF THE DRAWINGS

FIG. 1 is a flowchart showing a method according to an embodiment of the present invention.

FIG. 2 is a diagram showing an increasing uncertainty along a trajectory of a mobile scanning operation.

FIG. 3 is a diagram showing a method of calculating and illustrating uncertainty in a mobile scanning operation.

FIGS. 4A to 4D are illustrations of a visual indicator of uncertainty in a point cloud.

FIG. 5 is an illustration of regions of a point cloud generated by a mobile scanning operation overlaid onto a ground-truth point cloud.

FIG. 6 is a graph showing uncertainties in results of a mobile scanning operation.

### DETAILED DESCRIPTION

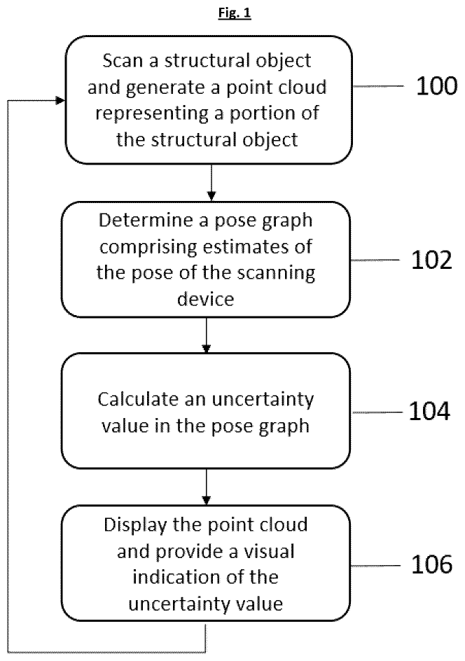

FIG. 1 is a flow diagram illustrating a method which is an embodiment of the present invention. The steps 100-106 of the method are performed multiple times, and following the performance of step 106 the method returns to step 100. This may continue until a user decides to terminate the process.

In step 100 a scan is made of a structural object from a certain location. The structural object may be a building, for example, although it may alternatively be any other product of the construction industry such as a tunnel, an earthwork, or an oil platform or rig. The scan is undertaken using a scanning system (apparatus) comprising a mobile scanning device at the location, and a display which may be provided in the same housing as the mobile scanning device. The scanning device preferably comprises a Lidar sensor. The scanning device may further comprise an inertial measurement unit (IMU). An IMU may be configured to measure the specific force, angular rate, and optionally the orientation of the scanner. A camera may be optionally included to capture image data to be used to colourize a point cloud generated based on the scanning (e.g. upon a user command; the user may issue this command, for example, following the performance of the method described below, when the display indicates that substantially the whole of the structural object has been scanned to the desired accuracy). The step of scanning the structural object comprises scanning the structural object from a plurality of successive locations, by moving the mobile scanning device along a trajectory.

The location may be different each time step 100 is performed. Step 100 may include a user moving in relation to the structural object (e.g. around the object and/or through the object, such as to successive rooms of the structural object) to a location, and at that location performing a plurality of distance measurements with respect to different points on the structural object using the mobile scanning device, to generate respective points of a point cloud. Thus, in each step 100, a corresponding point cloud is generated representing a portion of the structural object that is visible from the location. According to a variation of the present embodiment, the scan may be performed by a mobile vehicle, e.g. controlled by the user.

In step 102, a calculating unit of the scanning apparatus is configured to determine a pose graph from the point clouds comprising estimates of positions of the successive locations in relation to the structural object. Additionally the pose graph may be determined based on IMU measurements. The pose graph includes a set of key poses. The key poses refer to the translational position and/or orientation of the scanner at at least some of the locations where a point cloud is collected. The origin location of the scan may also be a key pose.

Optionally, point clouds may also be collected at poses which are not considered key poses because their translation and/or orientation relative to the preceding key pose is determined to be less than a predetermined threshold. For example, the predetermined translational threshold may be 1 metre, and the predetermined rotational threshold may be 35 degrees.

The key poses are typically defined in a common three-dimensional co-ordinate system. Using the set of key poses the scanning system aligns the corresponding point clouds in the common three-dimensional co-ordinate system. For example, if multiple ones of the point clouds include points which image the same portion of a structural object, the alignment brings the points which image that portion of the structural object into positional register (translational and rotational register). Similarly, the alignment brings the points which image different portions of the structural object into a positional relationship which reflects the actual positional relationship of those portions of the structural object. The aligned point clouds may be referred to as a “composite point cloud”. The above method may comprise performing feature extractions from successive Lidar scans and then registering these features together using an Iterative Closest Point algorithm with a custom objective function. The registration will yield an odometric measurement (a Euclidean 6-Degree-of-Freedom transformation, zᵢ) between the two successive Lidar scans. The method described in Zhang, J., & Singh, S. (2014 July). LOAM: Lidar odometry and mapping in real-time. In Robotics: Science and Systems (Vol. 2, No. 9, pp. 1-9), may be used to perform the feature extraction and registration.

Optionally, the method may comprise using both Lidar and IMU measurements to align the point clouds. Using an IMU significantly improves the robustness of inter-pose constraints/measurements (zᵢ) in cases when a user performing the scan moves quickly, or when successive Lidar scans have failed to align due to there being insufficient features present in those scans. In such cases, the method described in Shan, T. at al. (2020). LIO-SAM: Tightly-coupled Lidar Inertial Odometry via Smoothing and Mapping, may be used to estimate an odometric measurement, zᵢ.

Any error in the key poses will result in misalignment of the point clouds when forming the composite point cloud, and so the composite point cloud will be skewed. This results in a spatial error between the composite point cloud and the underlying ground truth.

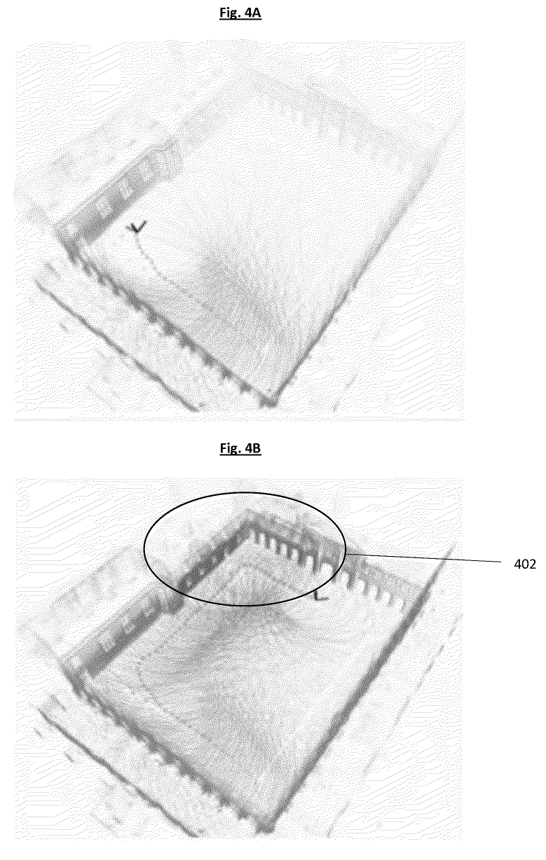

In step 104, an uncertainty value is calculated for each location in the pose graph. A way in which this is done is explained below with reference to FIG. 3.

In step 106, the point clouds are displayed. Each point is displayed in a manner (e.g. colour coded) according to the uncertainly value of the corresponding location.

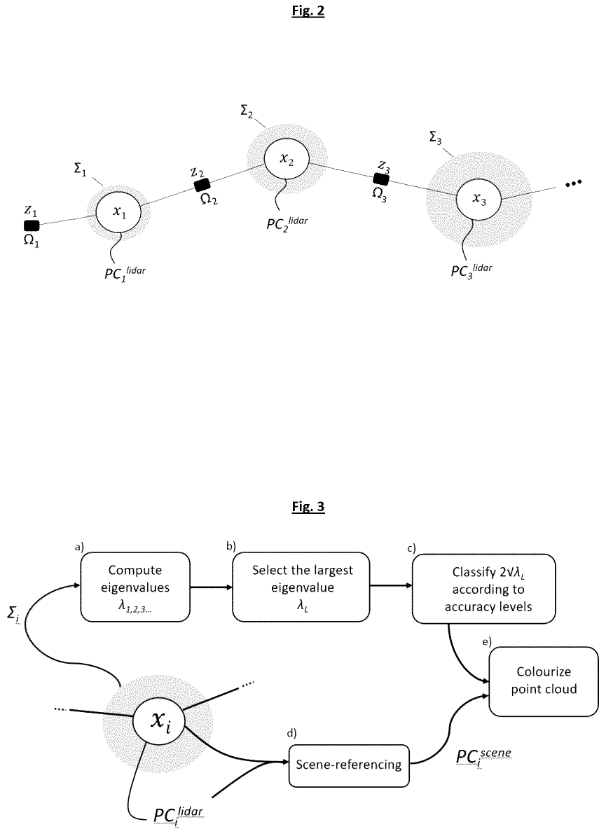

We now turn to a more detailed explanation of step 102 of FIG. 1. FIG. 2 illustrates part of progressively-built trajectory X consisting of a sequence of locations labelled by an integer index i. For each location i, a corresponding point cloud is captured by the mobile scanner device (Lidar scanner), and denoted PCᵢ^{lidar} in the reference frame of the Lidar scanner. The position and orientation of the sequence of locations in the three-dimensional coordinate system is a set of key poses {x₁, x₂, x₃, . . . }, collectively forming a pose graph. Each key pose comprises a corresponding a 3D rotation matrix (3×3) (R) and a corresponding translation vector (3×1) (T) defined in the coordinate system of the scene.

Black rectangles represent constraints Z including inter key-pose odometric transformations {z₁, z₂, z₃, . . . }. x¿ and zᵢ have the following relation:

$${x}_{i} = {z}_{i} {x}_{i - 1}$$

Both zᵢ and xᵢ may conveniently written as 4×4 matrices, comprising a corresponding matrix R and a corresponding vector T:

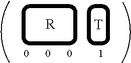

The 0s and 1s are provided in the final row as “padding” to simplify mathematical operations.

Each odometric transformation zᵢ is associated with a covariance matrix,

$${Ω}_{i}^{- 1} ,$$

which represents uncertainty on these transformations.

$${Ω}_{i}^{- 1}$$

is the inverse of a matrix Ωᵢ which may be called an information matrix.

The uncertainty of each key pose x; is encoded in a corresponding marginal covariance matrix Σᵢ. Σᵢ is a 6×6 covariance matrix. It relates to three rotational and three translational components. The variance in all quantities is assumed to be jointly Gaussian, and because of this, it is possible to extract the portion of 2; which relates to the 3 translational variables, as a 3×3 matrix.

In FIG. 2, the pose uncertainties are indicated by the grey circles surrounding the key poses {x₁, x₂, x₃, . . . }. As can be seen in FIG. 2, the uncertainty of the key poses increases as the distance from the location to the starting point of the trajectory increases.

It is known, as each location is added to the trajectory X, to use a Maximum A Posteriori (MAP) incremental non-linear pose-graph optimization approach to estimate the set of key poses {x} for all the locations of the trajectory X, such that their errors for the odometric inter key-pose and loop closure transformations zᵢ are the smallest. This can be expressed as requiring the minimisation of Equation (1):

$${X}^{MAP} = {min}_{\{ {x}_{i} \}} {\sum }_{i} {‖ {h}_{i} ( {x}_{i} ) - {z}_{i} ‖}_{{Ω}_{i}^{- 1}}^{2} \qquad ( 1 )$$

In Equation (1), hᵢ(.) are non-linear functions transforming key poses stored in the coordinate system of the scene to the coordinate system of the previous pose in which zᵢ is measured. For any vector e, the operation

$${‖ e ‖}_{{Ω}_{i}^{- 1}}$$

is defined as e^{T}Ωᵢe the squared Mahalanobis distance. Equation (1) is adapted from “iSAM2: Incremental Smoothing and Mapping with Fluid Relinearization and Incremental Variable Reordering”, by M. Kaess et al, in IEEE International Conference on Robotics and Automation, May 2011. Note that Kaess et al. is related to the field of robotics. Kaess's equation is modified here so that the measurement in Kaess becomes the zᵢ of the present embodiment. zᵢ can be used to transform a first pose xᵢ₋₁ to a subsequent pose xᵢ by the relation defined above.

The uncertainty/error {Ωᵢ} of the inter-pose constraints {z₁} can be propagated through the pose-graph so that the joint probability of the key poses can be computed. From there, uncertainty {Σᵢ} on the individual poses can be calculated through the means of marginal covariances. There are known real-time methods to recover the marginal covariances of the key poses after the propagation. Some of these techniques are explained, for example in the following references: “Factor Graphs and GTSAM,” GTSAM, May 22, 2019. http://gtsam.org/tutorials/intro.html; G. D. Tipaldi, G. Grisetti, and W. Burgard, “Approximate Covariance Estimation in Graphical Approaches to SLAM,” in 2007 IEEE/RSJ International Conference on Intelligent Robots and Systems, October 2007, pp. 3460-3465; M. Kaess and F. Dellaert, “Covariance recovery from a square root information matrix for data association,” Robot. Auton. Syst., vol. 57, no. 12, pp. 1198-1210, Grudzie, 2009; and V. Ila, L. Polok, M. Solony, P. Smrz, and P. Zemcik, “Fast covariance recovery in incremental nonlinear least square solvers,” in 2015 IEEE International Conference on Robotics and Automation (ICRA), May 2015, pp. 4636-4643.

The following is a summary of how marginal covariance matrices are recovered using the techniques in these references. Equation 1 involves progressively solving non-linear least squares. In order to solve them, the following steps may be performed:
(1) locally linearize the equation at a given state of X (state of the trajectory);
(2) solve the normal equation of the form Δ=(A^{T}A)⁻¹A^{T}b, where A is a Jacobian, A^{T} A is the information matrix, b is an error vector after linearization, and A is a step that must be taken in order to get closer to the minimum of Equation 1.

(3) repeat steps 1 and 2 until convergence.

After convergence, the equation can still be linearized at the optimized state of the trajectory, and A^{T} A which is the information matrix, can be computed. If the information matrix is inverted, the covariance matrixΣ=(A^{T}A)⁻¹ is acquired. Kaess and Dellaert (2009) showed how estimating the marginal covariance Σi as part of Σ may be performed in acceptable time.

Turning to FIG. 3, a more detailed explanation is given of steps 104 and 106 of FIG. 1. FIG. 3 comprises steps (a)-(c) which correspond to step 104 of FIG. 1, and steps (d)-(e) which correspond to step 106 of FIG. 1.

The process of FIG. 3 employs the pose xᵢ and the Σᵢ found in step 102 for each of the locations for which point clouds have previously been located.

In step (a) of FIG. 3, the greatest variance is progressively computed for each marginal covariance matrix Σᵢ associated with the new key pose xᵢ. This ensures that the maximal translational error for the new key pose is found. When no loop closure is achieved by a new key pose, there is no MAP optimization whenever a new key pose appears in the pose graph, so the marginal covariance of the new key pose can be computed without re-computing all the previous poses.

However, after a loop closure, the uncertainty in the whole trajectory changes significantly, so there the marginal covariances are recomputed for all the poses.

Given that the errors along each of the three axes might be correlated, the eigenvalues λₖ of the covariance matrix Σᵢ are computed in step (a) of FIG. 3 according to Equation (2). vₖ is an eigenvector associated with the corresponding eigenvalue λₖ.

$${\sum }_{i} {v}_{k} = {λ}_{k} {v}_{k} \qquad ( 2 )$$

The largest eigenvalue, denoted λ_{L}, is picked in step (b) of FIG. 3. This value is indicative of the variance of the distribution of xᵢ in the direction of maximum variance. This distribution may be assumed to be a Gaussian distribution.

In step (c), the square root of the largest eigenvalue λ_{L} is obtained, which is the standard deviation of the distribution in the direction in which the standard deviation is greatest. This is multiplied by a confidence factor, such as 2, to define an uncertainty value. Thus, the uncertainty value is the confidence factor multiplied by the standard deviation. It represents an upper limit for the spatial error in the estimate of the translational position encoded in xᵢ. The spatial error is below this upper limit with a confidence level dependent on the confidence factor. For example, when the confidence level is 2, a 95% confidence level on the maximal translation error of the current pose is obtained. Other confidence levels could, however, be used, and the present disclosure is not limited to a confidence value of 95%.

The uncertainty value (i.e. the product of the confidence factor and the largest eigenvalue λ_{L}) is then compared to the one or more acceptability thresholds, defining corresponding accuracy bands. Before scanning starts, the user chooses which standard guidance document he or she wants to comply with, and based on this choice the system determines a tolerance distance value which is may be used as one of the acceptability threshold(s). The system then compares 212, for each key pose against the acceptability threshold(s). If there is only a single acceptability threshold, the comparison determines whether each location has an uncertainty value above or below that accuracy threshold. If there are multiple acceptability thresholds, the comparison determines which of at least three ranges defined by the acceptability thresholds the uncertainty values fall into (e.g. an uncertainty value above the highest acceptability threshold; an uncertainty value between the lowest acceptability threshold; and range(s) defined by respective adjacent pair(s) of the acceptability thresholds).

In step (d), for each new key pose, Lidar points

$${PC}_{{i}^{lidar}}$$

in the coordinate system of the Lidar scanner are transformed to points

$${PC}_{{i}^{scene}}$$

in the common three-dimensional coordinate system according to Equation (3).

$${PC}_{i}^{scene} = {x}_{i} {PC}_{i}^{lidar} \qquad ( 3 )$$

xᵢ,

$${PC}_{{i}^{lidar}} and {PC}_{{i}^{scene}}$$

are conveniently stored in homogenous coordinates. The process of determining

$${PC}_{i}^{scene}$$

(including determining the {xᵢ} is referred to as scene-referencing. The set of aligned point clouds

$$\{ {PC}_{i}^{lidar} \}$$

form the composite point cloud.

In step (e) of FIG. 3, the scene-referenced Lidar point clouds for each location are displayed concurrently on a screen, for example as a perspective image of the composite point cloud. Each point may be colour coded according to the result of the comparison in step (c) for the corresponding location, i.e. according to which of the ranges the uncertainty value for the corresponding location was determined to lie in. Points for which the corresponding location has an uncertainty value is below the lowest acceptability threshold (i.e. locations for which the pose has the highest accuracy level) are coloured e.g. green, while points for which the corresponding location has an uncertainty value above the highest acceptability threshold are coloured e.g. red. All levels in between may be colourized according to hues in between these two, such as yellow, amber and orange. In this way, the user scanning a scene can see what the predicted correctness of the progressively growing composite point cloud is in real time.

There may be five different hues used in total, each corresponding to the Levels of Accuracy (LOAs) specified by the US Institute of Building Documentation (2016). In their document, the most stringent level has an uncertainty 5 times smaller than the least stringent level. The system may be designed to show a green point cloud when the predictions meet the most stringent level and red when the predictions do not meet the least stringent level. Therefore, if the point cloud shows the full range of colours, the predicted error would be at least 5 times higher in a red area than in a green area.

Other colour coding schemes may be applied. In the case where the scanning system is unable to meet the requirements of the lowest (most stringent) acceptability threshold(s), the highest acceptability threshold(s) may be increased by the user. In such a case, any of the poses for which 211, is smaller than the lowest acceptability threshold(s) will remain green. Similarly, once a certain proportion of the point clouds are green, the user may choose to reduce the acceptability thresholds, to make the comparison more stringent.

The visualization system presented above can be used in the following way. Before scanning starts, the user chooses a lower level of point cloud accuracy (acceptability threshold) he or she is willing to accept. This may be chosen for example as a tolerance distance value specified by a surveying standard, such as those issued by the Royal Institution of Chartered Surveyors or the USIBD Level of Accuracy (LOA) specified by the US Institute of Building Documentation, 2016. Thus, one way for the user to select the acceptability threshold is to select a surveying standard, and the scanning system extracts the corresponding tolerance distance value from a memory for use in the method of FIG. 3. Optionally, as explained above, the user can select more than one acceptability threshold, so as to define more than two ranges for the uncertainty value.

As the user traverses the scene, the progressively-built point cloud gradually moves along the trajectory the colour of new point clouds changes colour from green to red, indicating that there is below 95% chance that the spatial error of the red regions of the scene is below the acceptability threshold. After the desired parts of the scene have been scanned, the user may revisit parts of the scene, e.g. those that are coloured red, such as by taking a different route to them relative to the structural object. By revisiting them, the user closes loops in the underlying pose graph representing the trajectory of the scanner, hence adding additional constraints to the graph. The underlying SLAM optimization process then shifts the trajectory, and hence the Lidar points to a more correct position, based on these additional constraints. This increases the confidence level in the correctness of the key poses and scene-referenced Lidar points.

The uncertainties on inter key-pose constraints and loop closures, {Ωᵢ}, may be manually trained in a situation where a known spatial error of a point cloud created by a SLAM system of choice is known. This spatial error can be measured by comparing the point cloud to a ground-truth point cloud created by more precise methods such as those in which terrestrial laser scanners are used in conjunction with standard surveying practices. More specifically, after propagating the {Ωᵢ} through the SLAM system during scanning, the user may tune the {Ωᵢ} in such a way that after their propagation, the 2√λ_{L} value related to a pose is equal to the known spatial error of a specific point cloud region which is closest to that pose.

For hand-held Lidar scanners with pose-graph SLAM, real-time predictions on the correctness of the produced point cloud can enable the user to make informed corrective actions during the scanning process, thus increasing the correctness of the point cloud. The corrective actions may comprise revisiting previous parts of the scene in an informed way.

### EXAMPLE

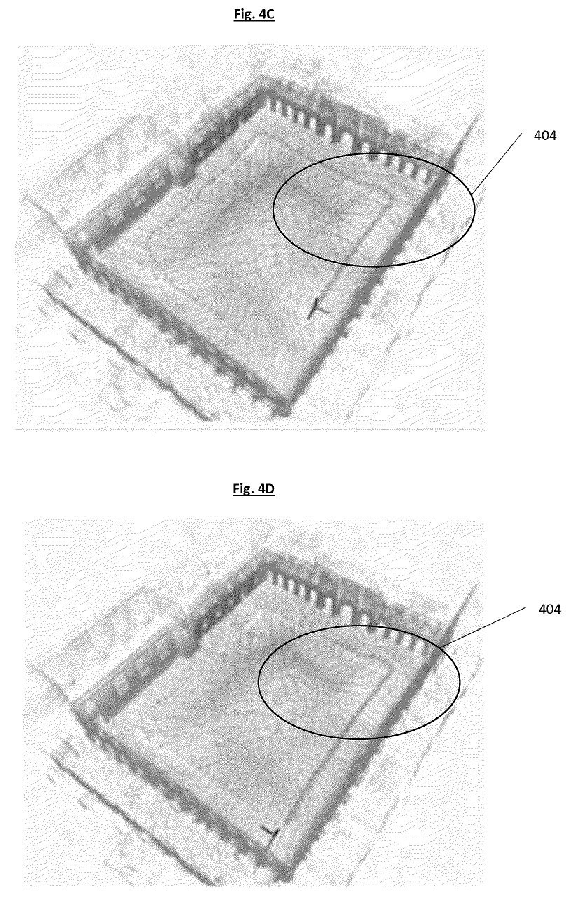

FIGS. 4A to 4D depict a point cloud progressively-built in real-time with overlaid uncertainty as an example of the above-described method. In this example, a user walked along four walls of a college quadrangle so that the façade was captured, and then returned to the place he started scanning to close a loop. The estimated trajectory of the scanner can be seen in FIGS. 4A to 4B. In addition, a FARO Focus 3D terrestrial scanner was used to provide a ground truth scan. The scanner was placed in the middle of the court so that it could cover all four façades.

In FIGS. 4A to 4D, light grey (representing green) shading indicates high point cloud correctness while dark grey (representing red) shading indicates predictions for a relatively higher spatial error as indicated in the region 402. As the user traverses the scene, the drift increases and so does the estimated spatial error in the newly accumulated points. This is shown by a gradual darkening of the tone (as would be shown in amber on the display) in FIG. 4B, predicting that the relative error in these places is around 3-4 times higher than in the bottom part of the scene. Having this information and following the above-described method, the user may decide to return to the light grey area to close the loop and potentially increase the correctness of the dark grey points. However, as the user moves towards the origin of the scanning, the newly reconstructed parts of the scene on the right side of the scene turn even darker grey, as seen in the region 404 in image 4C, indicating that the error there might be 5 times higher than in the light grey areas. Finally, the loop is closed in FIG. 4D, and the points around this area turn light grey. The system predicts that their spatial error decreased significantly. However, the points in the corner at the top part still retain moderate levels of uncertainty.

Considering FIG. 4, the actual spatial error in the top left corner has been investigated and contrasted with the spatial error in the top right corner, which should have a relatively lower error according to the predictions of the present system.

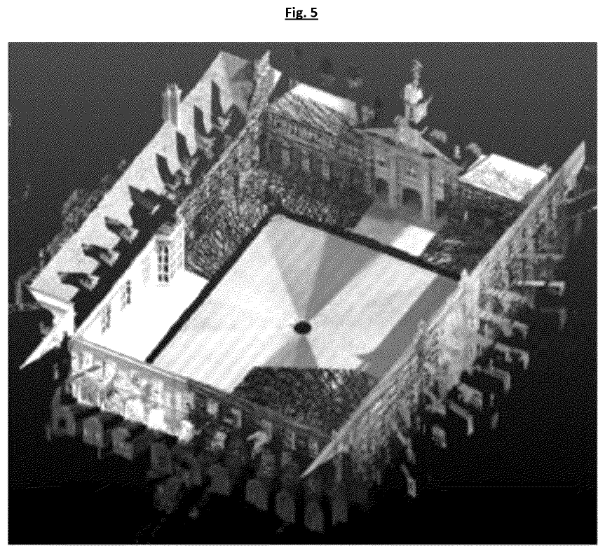

FIG. 5 shows 3 regions of a point cloud generated by the mobile scanner overlaid onto a ground-truth point cloud. The point cloud generated by the scanner was segmented into three regions (darkly shaded in FIG. 5): the one at the bottom of the figure was used to register the whole point cloud by the mobile scanner to the ground-truth point cloud by the FARO Focus 3D scanner; the one at the top of the figure was predicted by the system as having a bigger spatial error (see FIG. 4D); finally, the region in the top right of the figure was predicted for a relatively lower spatial error than the previous region after the loop closure, although initially, the error there was even higher than that at the top corner.

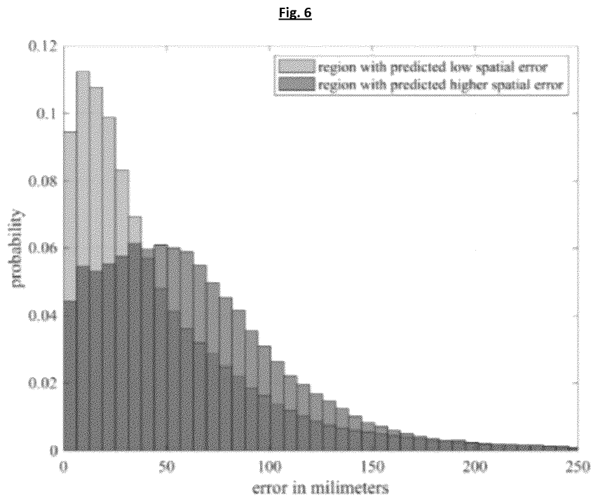

For the top two regions, distances to the ground truth scan were computed using Cloud Compare. Next, they were binned and presented as histograms in FIG. 6. On these distances, three statistics: 1) a mode (most likely value), a mean (average value) and a 95-percentile were also computed. See Table 1 below.

TABLE 1

| | Region with | Region with |
|---|---|---|
| | predicted low | predicted higher |
| | spatial error | spatial error |
| Statistics | [mm] | [mm] |
| Mode | 10 | 47 |
| Mean | 46 | 64 |
| 95-percentile | 140 | 149 |

Judging by the modes in Table 1, the blue region at the top of FIG. 5 has almost 5 times higher most likely spatial error than the point cloud in the top right corner (47 and 10 mm respectively). It also has around 39% higher mean error, and its 95-percentile is larger by 9 mm. These three statistics confirm that the system of the present application correctly predicted the regions of relatively higher spatial error.

In this case study, the top corner marked in red in FIG. 4D still has lower accuracy compared to the green part. The informed user could walk up to the corner while scanning, diagonally through the quadrangle, and close the second loop. This would further reduce the uncertainty, especially in that region, hence decreasing the error.

Although not described in the above example, the display may indicate a corrective action to be performed by the user to reduce the uncertainty in the point cloud. For example, the display may display an arrow that indicates a direction in which the user should travel from the most recent location to reduce spatial error (e.g. if the user is at a location associated with a high uncertainty value, a direction to a nearby location with a low uncertainty value; or vice versa), or may indicate a location to which the user should return.

In summary, the present disclosure provides a novel, fully-explainable method for real-time predictions of areas with potentially high spatial error in progressively created point clouds by Lidar mobile scanners. The method exploits the human-machine interaction and is suitable for SLAM systems based on pose graphs.

The disclosed system can help the construction industry to reduce the effort (time and money) put generally into scanning construction sites. Since the user is aware of the regions of potentially high spatial error during scanning, they can take corrective actions on-the-fly, and not after the data collection and processing have been completed. This, in turn, eliminates the potential risk of requiring re-scanning.

Many variations are possible within the scope of the invention. For example, as noted above, a Lidar scanner typically includes an IMU to improve robustness in the calculation of the key poses. In this case, the calculation of the marginal covariance matrix of each key pose may be based on the IMU data, for example in addition to being based on the point cloud data.

1. A system for scanning a structural object, comprising:
a mobile scanning device configured to scan the structural object from a plurality of successive locations to generate for each location a respective point cloud representing a respective portion of the structural object;
a calculating unit configured to:
(i) determine from the point clouds a pose graph comprising estimates of positions of the successive locations in relation to the structural object; and
(ii) calculate for each location a respective uncertainty value in the pose graph; and
a display configured to display the point clouds and to provide a visual indication for each point cloud of the calculated uncertainty value of the corresponding location in the pose graph.

2. A system according to claim 1 in which the calculating unit is configured to determine the pose graph by optimizing, with respect to the estimates of the positions of the successive locations, a maximum-a-posteriori loss function of the estimates of the positions of the successive locations.

3. A system according to claim 2 in which in which the optimization of the maximum-a-posteriori loss function comprises deriving for each location a respective covariance matrix, the uncertainty value for each location being based on a highest eigenvalue of the covariance matrix.

4. A system according to claim 3 in which the uncertainty value is a confidence factor multiplied by the square root of the highest eigenvalue.

5. A system according to any preceding claim 1, wherein the visual indication for each point cloud indicates whether the uncertainty value of the corresponding location is respectively above or below a predetermined acceptability threshold.

6. A system according to claim 5 which is operative to receive a user selection of the acceptability threshold.

7. A system according to claim 6 in which the user selection indicates a selection of a surveying standard, and the calculating unit is configured to determine the acceptability threshold based on a tolerance distance value associated with the selected standard.

8. A system according to claim 1, wherein the visual indication for each point cloud is a colour of displayed points of the displayed point cloud.

9. A system according to claim 1 wherein the mobile scanning device comprises a Lidar sensor.

10. A system according to claim 9 wherein the mobile scanning device further comprises an inertial measurement unit.

11. A system according to claim 1, further comprising an indication unit configured to indicate corrective action to be performed by a user to reduce the levels of uncertainty in the pose graph.

12. A system according to claim 11 wherein the corrective action comprises closing a loop in the pose graph.

13. A system according to claim 11, wherein the display displays an indication of the corrective action to be performed.

14. A system according to any preceding claim 1 in which the mobile scanning unit, calculating unit and display are provided within a common housing.

15. A method scanning a structural object, comprising:
scanning the structural object from a plurality of successive locations to generate for each location a respective point cloud representing a respective portion of the structural object;
determining from the point clouds a pose graph comprising estimates of positions of the successive locations in relation to the structural object;
calculating for each location a respective uncertainty value in the pose graph; and
displaying the point clouds and providing a visual indication for each point cloud of the calculated uncertainty value of the corresponding location in the pose graph.

16. A method according to claim 15 further comprising determining the pose graph by optimizing, with respect to the estimates of the positions of the successive locations, a maximum-a-posteriori loss function of the estimates of the positions of the successive locations.

17. A method according to claim 16 in which in which the optimization of the maximum-a-posteriori loss function comprises deriving for each location a respective covariance matrix, the uncertainty value for each location being based on a highest eigenvalue of the covariance matrix.

18. A method according to claim 17 in which the uncertainty value is a confidence factor multiplied by the square root of the highest eigenvalue.

19. A method according to claim 15, wherein the visual indication for each point cloud indicates whether the uncertainty value of the corresponding location is respectively above or below a predetermined acceptability threshold.

20. A method according to claim 19 further comprising receiving a user selection of the acceptability threshold.

21. A method according to claim 20 in which the user selection indicates a selection of a surveying standard, further comprising determining the acceptability threshold based on a tolerance distance value associated with the selected standard.

22. A method according to claim 15, wherein the visual indication for each point cloud is a colour of displayed points of the displayed point cloud.

23. A method according to claim 15 further comprising indicating corrective action to be performed by a user to reduce the levels of uncertainty in the pose graph.

24. A method according to claim 23 wherein the corrective action comprises closing a loop in the pose graph.

25. A method according to claim 23 further comprising displaying an indication of the corrective action to be performed.
